(19) United States
(12) Patent Application Publication
(10) Pub. No.: US 2017/0276504 A1
(43) Pub. Date: Sep. 28, 2017

(54) Vehicular Traffic Assistance Based on Traffic Management Decisions

(71) Applicant: TOYOTA JIDOSHA KABUSHIKI KAISHA, Toyota-shi (JP)

(72) Inventors: Hongsheng LU, Fremont, CA (US); Gaurav BANSAL, San Jose, CA (US); John KENNEY, Santa Clara, CA (US); Toru NAKANISHI, Toyota-shi (JP)

(21) Appl. No.: 15/077,756

(22) Filed: Mar. 22, 2016

(51) Int. Cl. G01C 21/34; G08G 1/0967; G08G 1/0968; G01C 21/36

(52) U.S. Cl. CPC G01C 21/3492; G01C 21/3691; G08G 1/096775; G08G 1/096844; G01C 21/3415

(57) ABSTRACT

The disclosure includes a system and method for providing vehicular traffic assistance. The method may include wirelessly providing a first navigation route to a navigation system of the vehicle to assist the vehicle to arrive at a destination, where the first navigation route includes one or more roadways for the vehicle to travel to arrive at the destination. The method may include receiving decision data from a roadway authority. The decision data may describe a set of traffic management decisions made by the roadway authority that affect travel along at least one of the roadways included in the first navigation route. The method may include proactively determining a second navigation route to assist the vehicle to arrive at the destination, where the second navigation route is configured so that it does not include any roadway that is affected by the set of traffic management decisions made by the roadway authority.

### BACKGROUND

The specification relates to vehicular traffic assistance based on traffic management decisions.

Vehicles may be manufactured to include navigation systems. The navigation systems may work with a cloud server to determine navigation choices for the user, driving instructions for the navigation choices they select and estimated time of arrivals (“ETA”) during the journey associated with the selected navigation choice.

For example, a user may interact with the in-vehicle navigation system to identify the nearest gas station. The navigation system may communicate the query to the cloud server. The query may include a search term, such as “Gas station” in this example, and global positioning system (“GPS”) data describing the geographic location of the vehicle as determined by the vehicle's GPS unit. The cloud server may search its directory data to identify a set of gas stations that are near the geographic location of the vehicle and navigation instructions associated with each gas station included in the set of gas stations. The set of gas stations in this example are “navigation choices.” The cloud server may wirelessly transmit data to the navigation system describing the navigation choices. A screen of the navigation system may display the navigation choices as options from which the user may select. The user may select one of the gas stations, which is now a “selected navigation choice” or “selected navigation route” based on being selected by the user. The navigation system may provide navigation instructions to assist the user to drive to the gas station as well as an ETA that describes the estimated amount of time it will take the vehicle to reach the selected navigation choice. The ETA may be updated by the cloud server as the vehicle gets closer to the destination.

### SUMMARY

Disclosed are implementations for improving the ETA and navigation instructions for vehicles using one or more of the following: (1) real time traffic management decisions made by roadway authorities; (2) basic safety message (“BSM”) data received from vehicles; and (3) dedicated short range communication probe data (“DSRC probe data”) received from vehicles.

A roadway authority includes a government agency or private entity that is responsible for managing, operating or maintaining one or more roadway systems within a geographic region. For example, in San Jose, Calif., the Santa Clara Valley Transportation Authority is a roadway authority for the geographic region of the city of San Jose. Other roadway authorities may be present in other geographic regions. Some geographic regions may include a plurality of roadway authorities.

The real time traffic decisions of the roadway authorities may themselves be improved by aggregated BSM data and DSRC probe data.

The improved ETA and navigation instructions provided to the vehicles may be on a lane-by-lane level of granularity. For example, each of the vehicles that transmits the BSM may be equipped with a DSRC-compliant GPS unit that is operable to provide GPS data that describes the location of the vehicle to a lane-level degree of precision. The DSRC standard requires that GPS data be precise enough to infer if two vehicles are in the same lane. The DSRC-compliant GPS unit may be operable to identify, monitor and track its two-dimensional position within 1.5 meters of its actual position 68% of the time under an open sky. Since lanes are typically no less than 3 meters wide, whenever the 2D error of the GPS data is <1.5 meters the assistance server described herein may analyze the GPS data and know what lane of the roadway system the vehicle is traveling in based on the relative positions of vehicles on the road.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method implemented by a computer system to assist a vehicle, the method including: wirelessly providing a first navigation route to a navigation system of the vehicle to assist the vehicle to arrive at a destination, where the first navigation route includes one or more roadways for the vehicle to travel to arrive at the destination; receiving decision data from a roadway authority, where the roadway authority is an entity that is responsible for operating a set of roadway systems in a geographic region and the decision data describes a set of traffic management decisions made by the roadway authority that affect travel along at least one of the roadways included in the first navigation route; identifying that the vehicle is affected by the set of traffic management decisions made by the roadway authority based on GPS data received from the vehicle indicating that the vehicle is traveling along the first navigation route; proactively determining a second navigation route that will assist the vehicle to arrive at the destination, where the second navigation route is configured by the computer system so that it does not include any roadway that is affected by the set of traffic management decisions made by the roadway authority; and wirelessly providing the second navigation route to the navigation system of the vehicle to assist the vehicle to arrive at the destination and avoid being affected by the set of traffic management decisions made by the roadway authority. Other embodiments of this aspect include corresponding computer systems, apparatus, and computer programs recorded on one or more computer storage devices, each configured to perform the actions of the methods.

Implementations may include one or more of the following features. The method where the set of traffic management decisions made by the roadway authority includes one or more of opening closing a lane or opening the lane. The method where the set of traffic management decisions made by the roadway authority includes closing an exit. The method where the set of traffic management decisions made by the roadway authority include reconfiguring a flow of traffic in a bidirectional lane. The method where the set of traffic management decisions made by the roadway authority includes closing a bridge. The method where the set of traffic management decisions made by the roadway authority includes rerouting traffic. The method where the set of traffic management decisions made by the roadway authority includes metering traffic in an on-ramp. The method where the set of traffic management decisions made by the roadway authority includes controlling traffic lights. The method where the GPS data is accurate to within 1.5 meters under an open sky. The method where the second navigation route is determined in substantially real time upon receipt of the decision data. The method where the decision data is received in substantially real time upon the decision being made by the roadway authority. The method where the decision data is received prior to the decision being implemented by the roadway authority. The method where the decision data is received via a wireless network that communicatively couples the computer system to a network-enabled device operated by the roadway authority. The method where the decision data is determined by the roadway authority based at least in part on a set of BSM data included in a set of BSMs broadcasted by a set of vehicles traveling along the set of roadway systems in the geographic region, where BSM data includes one or more of the following: a set of GPS data describing locations for the set of vehicles; a set of heading data describing directions of travel for the set of vehicles; a set of velocity data describing velocities of the set of vehicles; a set of path history data describing historical paths of travel for the set of vehicles.

One general aspect includes a method to assist a vehicle, the method including: wirelessly providing a navigation route to a navigation system of the vehicle to assist the vehicle to arrive at a destination, where the navigation route includes one or more roadways for the vehicle to travel to arrive at the destination; determining a first estimated time of arrival (“first ETA”) associated with the navigation route by estimating how long it will take the vehicle to travel the navigation route and arrive at the destination by traveling the navigation route; wirelessly providing a first ETA to the navigation system of the vehicle for display to a user of the vehicle; receiving decision data from a roadway authority, where the roadway authority is an entity that is responsible for operating a set of roadway systems in a geographic region and the decision data describes a set of traffic management decisions made by the roadway authority that affect travel along at least one of the roadways included in the navigation route; proactively determining a second estimated time of arrival (“second ETA”) associated with the navigation route by estimating how long it will take the vehicle to travel the navigation route which is affected by the set of traffic management decisions and arrive at the destination by traveling the navigation route; and wirelessly providing the second ETA to the navigation system of the vehicle for display to a user of the vehicle. Other embodiments of this aspect include corresponding computer systems, apparatus, and computer programs recorded on one or more computer storage devices, each configured to perform the actions of the methods.

One general aspect includes a method implemented by a computer system operable to assist a vehicle, the method including :receiving decision data from a roadway authority, where the roadway authority is an entity that is responsible for operating a set of roadway systems in a geographic region and the decision data describes a set of traffic management decisions made by the roadway authority that affect travel along one or more roadways included in the geographic region; receiving a request for navigation instructions to a destination from the vehicle; determining a navigation route that will assist the vehicle to arrive at the destination, where the navigation route includes a set of roadways to be traveled by the vehicle and the one or more roadways included in the set of roadways are selected by the computer system so that they do not include any roadway that is affected by the set of traffic management decisions made by the roadway authority; and wirelessly providing the navigation route to a navigation system of the vehicle to assist the vehicle to arrive at the destination and avoid being affected by the set of traffic management decisions made by the roadway authority. Other embodiments of this aspect include corresponding computer systems, apparatus, and computer programs recorded on one or more computer storage devices, each configured to perform the actions of the methods.

One general aspect includes a method to assist a vehicle, the method including: wirelessly providing a first navigation route to a navigation system of the vehicle to assist the vehicle to arrive at a destination, where the first navigation route includes one or more roadways for the vehicle to travel to arrive at the destination; wirelessly receiving a set of BSMs describing a set of vehicles traveling along a set of roadway systems, each BSM included in the set of BSMs describing a specific vehicle included in the set of vehicles and including BSM data describing a lane of travel for the specific vehicle, a speed of travel for the specific vehicle and a heading of travel for the specific vehicle; analyzing the BSM data to identify a traffic event that affects travel along at least one of the roadways included in the first navigation route; identifying that the vehicle is affected by the traffic event based on GPS data received from the vehicle indicating that the vehicle is traveling along the first navigation route; proactively determining a second navigation route that will assist the vehicle to arrive at the destination, where the second navigation route is configured so that it does not include any roadway that is affected by the traffic event; and wirelessly providing the second navigation route to the navigation system of the vehicle to assist the vehicle to arrive at the destination and avoid being affected by the traffic event. Other embodiments of this aspect include corresponding computer systems, apparatus, and computer programs recorded on one or more computer storage devices, each configured to perform the actions of the methods.

Implementations may include one or more of the following features. The method where the traffic event includes a wreck. The method where the traffic event includes roadway construction. The method where the traffic event includes a traffic stop involving a police vehicle. The method where the traffic event includes a flooded lane. The method where the traffic event includes an icy patch on a roadway. Implementations of the described techniques may include hardware, a method or process, or computer software on a computer-accessible medium.

One general aspect includes a method to assist a vehicle, the method including: wirelessly providing a first navigation route to a navigation system of the vehicle to assist the vehicle to arrive at a destination, where the first navigation route includes one or more roadways for the vehicle to travel to arrive at the destination; wirelessly receiving, via a network that is not compatible with dedicated short range communication (“DSRC”), a set of DSRC probes describing a set of vehicles traveling along a set of roadway systems, each DSRC probe included in the set of DSRC probes describing a specific vehicle included in the set of vehicles and including DSRC probe data describing a lane of travel for the specific vehicle, a speed of travel for the specific vehicle, a heading of travel for the specific vehicle and a path of travel for the specific vehicle, where the DSRC probes are aggregated by a set of roadside units located proximate to one or more of the roadway systems included in the set of roadway systems; analyzing the DSRC probe data to identify a traffic event that affects travel along at least one of the roadways included in the first navigation route; identifying that the vehicle is affected by the traffic event based on GPS data received from the vehicle indicating that the vehicle is traveling along the first navigation route; proactively determining a second navigation route that will assist the vehicle to arrive at the destination, where the second navigation route is configured so that it does not include any roadway that is affected by the traffic event; and wirelessly providing the second navigation route to the navigation system of the vehicle to assist the vehicle to arrive at the destination and avoid being affected by the traffic event. Other embodiments of this aspect include corresponding computer systems, apparatus, and computer programs recorded on one or more computer storage devices, each configured to perform the actions of the methods.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A is a block diagram illustrating an example operating environment for an assistance system according to some implementations.

FIG. 1B is a block diagram illustrating an example operating environment for an assistance system according to some implementations.

FIG. 1C is a flowchart of an example method for providing assistance to selected vehicles traveling along a roadway based on traffic management decisions of a roadway authority, according to some implementations.

FIG. 2A is a block diagram illustrating an example operating environment for an assistance system according to some implementations.

FIG. 2B is a block diagram illustrating an example operating environment for an assistance system according to some implementations.

FIG. 3A is a block diagram illustrating an example operating environment for an assistance system according to some implementations.

FIGS. 3B-3D are a flowchart of an example method for providing assistance to selected vehicles traveling along a roadway based on DSRC-related data, according to some implementations.

FIG. 4A is a block diagram illustrating an example computer system including the assistance system according to some implementations.

FIG. 4B is a block diagram illustrating an example of BSM data according to some implementations.

FIG. 4C is a block diagram illustrating an example of BSM data according to some implementations.

### DETAILED DESCRIPTION

Vehicles are increasingly equipped with Dedicated Short Range Communication (“DSRC”). A vehicle equipped with DSRC may be referred to as “DSRC-equipped.” A DSRC-equipped vehicle may include a DSRC antenna and any hardware of software necessary to send and receive DSRC messages, generate DSRC messages and read DSRC messages. For example, a DSRC-equipped vehicle may include any hardware or software necessary to receive a DSRC message, retrieve data included in the DSRC message and read the data included in the DSRC message.

One type of DSRC message is known as a Basic Safety Message (“BSM” if singular or “BSMs” if plural). DSRC-equipped vehicles broadcast a BSM at a regular interval. The interval may be user adjustable. In some implementations, the BSM is broadcast at an adjustable rate of once every 0.10 seconds.

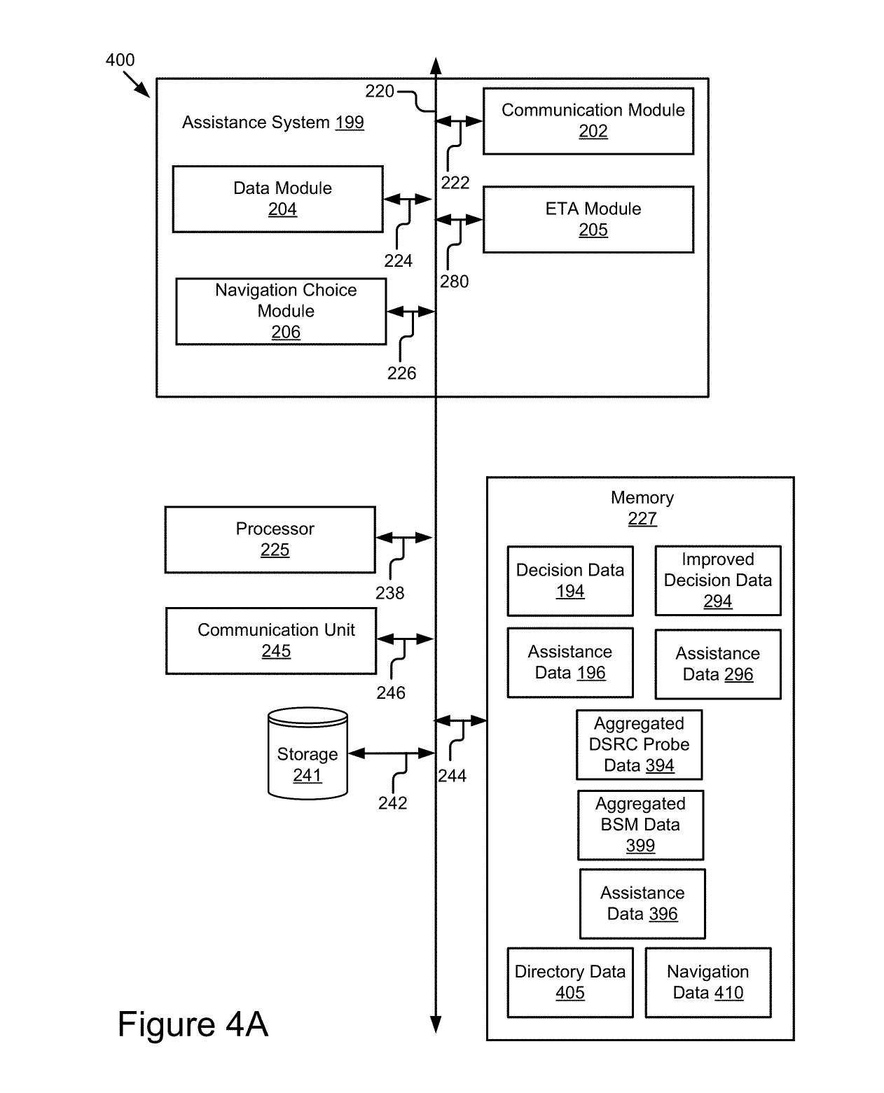

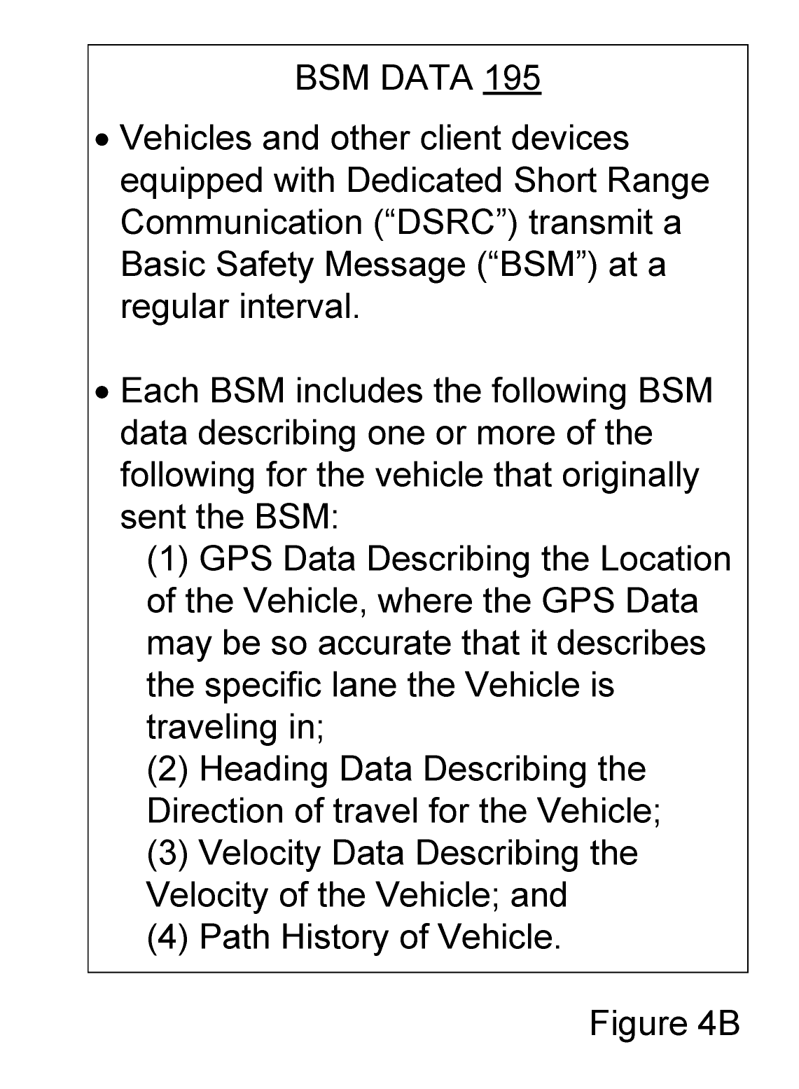

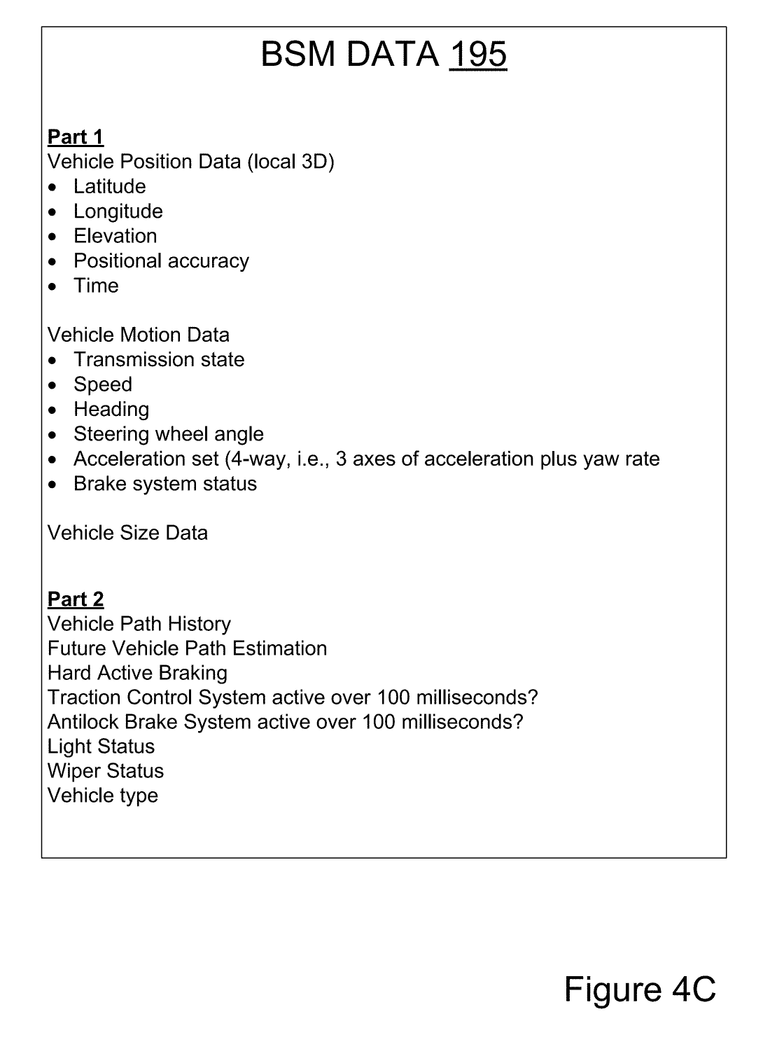

A BSM includes BSM data. The BSM data describes attributes of the vehicle that originally transmitted the BSM message. FIGS. 4B and 4C depict examples of BSM data according to some implementations. FIGS. 4B and 4C are described below.

Vehicles are also increasingly manufactured to include navigation systems. These navigation systems may provide ETA estimates and navigation choices to drivers that are based on GPS data and knowledge about queue lengths along roadways. However, our research has shown that ETA estimates and navigation choices are improved by knowledge about decisions made by roadway authorities or DSRC-based data that describes the current travel experience of vehicles present on the roadway at the same time the ETA estimates and navigation choices are delivered. The DSRC-based data may include BSM data or DSRC probe data.

Navigation choices and ETA estimates based on GPS data describing traffic volume or queue depths in the relevant geographic region are often out of date by the time it is actually used to generate ETA estimates or navigation choices. By contrast, described below are embodiments of an assistance system that provides navigation choices and ETA estimated to vehicles based on one or more of the following: (1) data describing the real time decisions of roadway authorities that will affect traffic flow for a navigation choice or selected navigation route; (2) aggregated BSM traffic data received from many vehicles (ten, dozens, hundreds, thousands, etc.) that describe their location, path history (and their future path); and (3) aggregated DSRC probe data received from many vehicles (ten, dozens, hundreds, thousands, etc.) that describe their location, path history (and their future path). The assistance system may use this data to generate ETA estimates and navigation choices that are intelligently adapted and responsive to real time events and roadway conditions that are described by the data.

In some implementations, the assistance system may provide a traffic assistant that improves ETA estimates and navigation choices for selected vehicles by taking advantage of access to real time traffic management decisions made by roadway authorities and DSRC-based data that is provided by vehicles that are traveling on roadways that are relevant to the selected vehicles.

Roadway authorities may include government departments that manage roadways for a geographic area. Roadway authorities may make decisions throughout the day that affect traffic flow. For example, a roadway authority may decide to close a lane of traffic, change the flow of traffic in a bidirectional lane of traffic, meter traffic flow in an on-ramp, etc. In some implementations, the assistance system described below may improve ETA estimates and navigation choices provided to vehicles based on information received from the roadway authorities describing the real time (or near real time) decisions they have made for a geographic area that is relevant to the driver of the vehicle.

Vehicles equipped with DSRC may broadcast BSMs at an adjustable rate. In some implementations, the rate may be once every 0.10 seconds. The BSM includes BSM data that describes, among other things, one or more of the following: (1) the path history of the vehicle that transmits the BSM; (2) the speed of the vehicle that transmits the BSM; and (3) the GPS-based location of the vehicle that transmits the BSM.

In some implementations, the roadway authorities may have access to BSM data to improve their decisions (closing a lane of traffic, changing the flow of traffic in a bidirectional lane of traffic, metering traffic flow in an on-ramp, etc.). For example, the roadway authorities may install DSRC-enabled traffic management devices proximate to one or more of the roadways they manage. These traffic management devices may receive the BSMs that include the BSM data. These traffic management devices may provide the BSM data to the roadway authorities who may analyze the BSM data to make improved traffic management decisions based on the BSM data. The roadway authorities may receive the BSM data in real time (or near real time). In some implementations, the assistance system may provide ETA estimates and navigation choices to vehicles based on the decisions of roadway authorities that have themselves been improved by access to BSM data related to the vehicles that are traveling on the roadways managed by the roadway authorities.

In some implementations, DSRC-equipped vehicles may probe other DSRC-equipped vehicles/devices along the roadway for information describing their current and future conditions, including their path history and future path. This information is described as “DSRC probe data.” In some implementations, the assistance system may improve ETA estimates and navigation choices provided to drivers of vehicles based on DSRC probe data aggregated from many DSRC-equipped vehicles.

In some implementations, the DSRC-enabled vehicles will include a DSRC-compliant GPS unit and the BSM data or DSRC probe data will specify which lane a vehicle is traveling in as well as its speed of travel and path history. In some implementations, the assistance system may use this information to: (1) adjust ETA data based on the actual lane the vehicle is traveling in; (2) provide recommendations to the driver about what their ETA would be if they changed lanes; and (3) provide navigation choices to the driver that include recommendations for which lane they should travel in to reduce ETA. Other uses are possible.

### System Overview

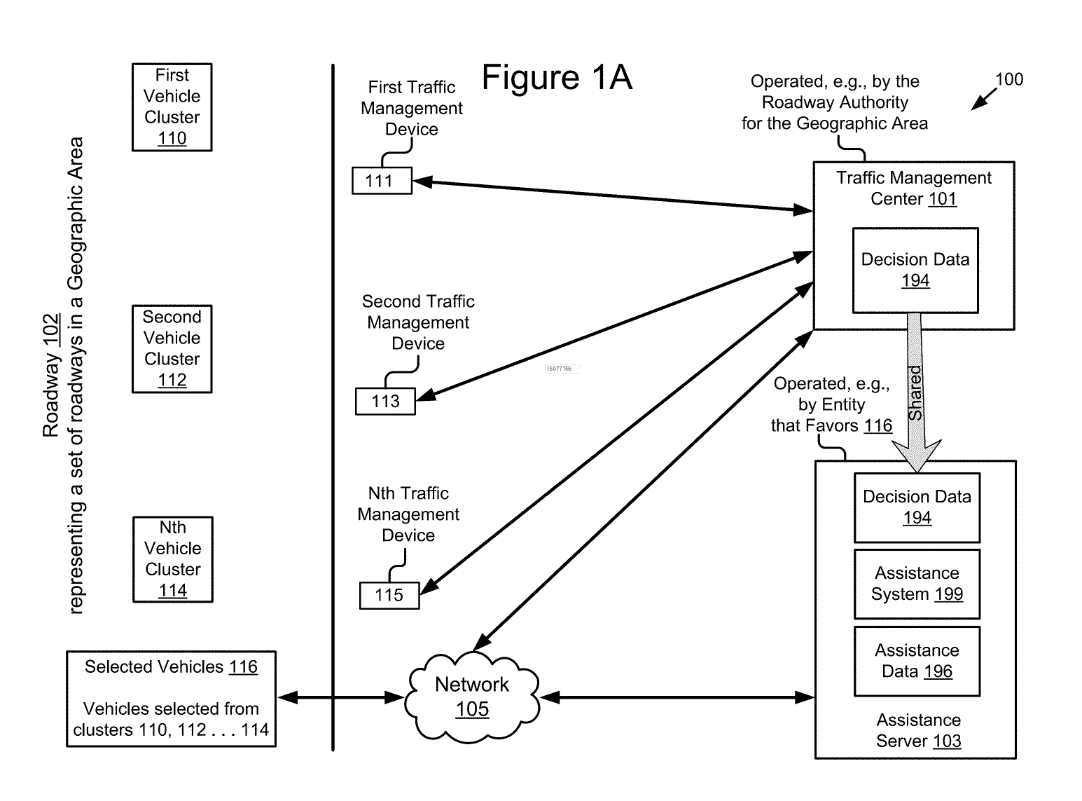

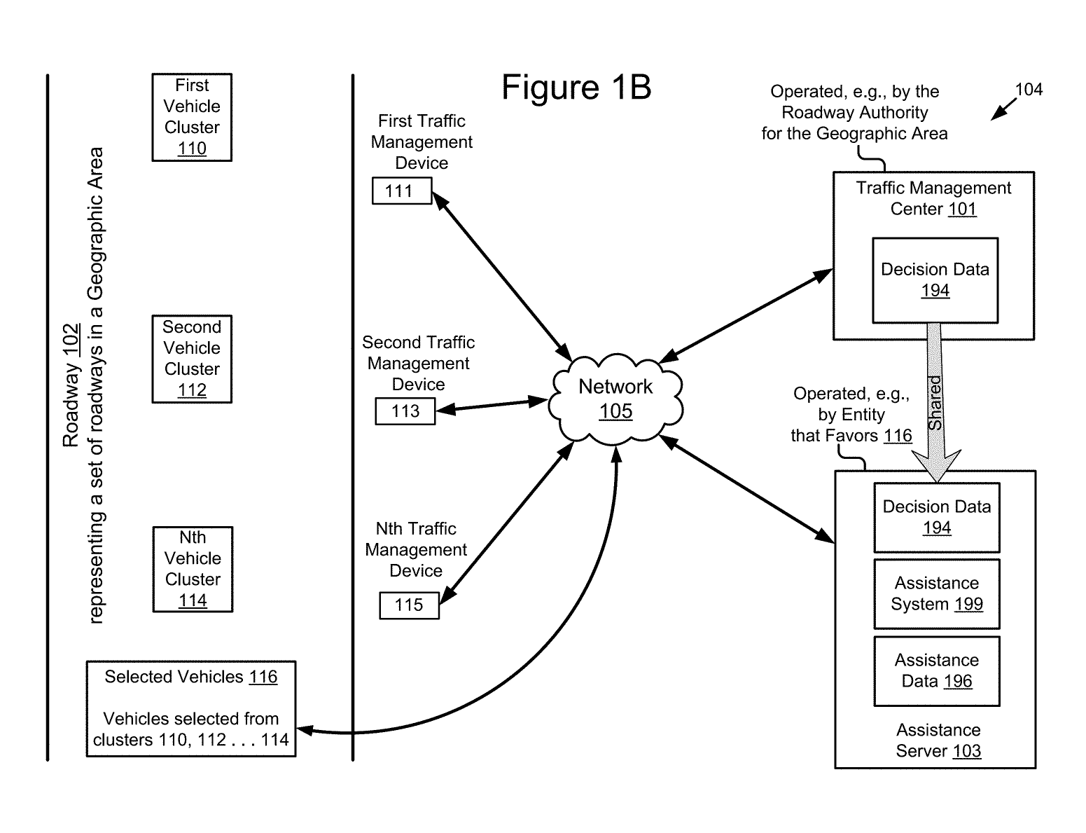

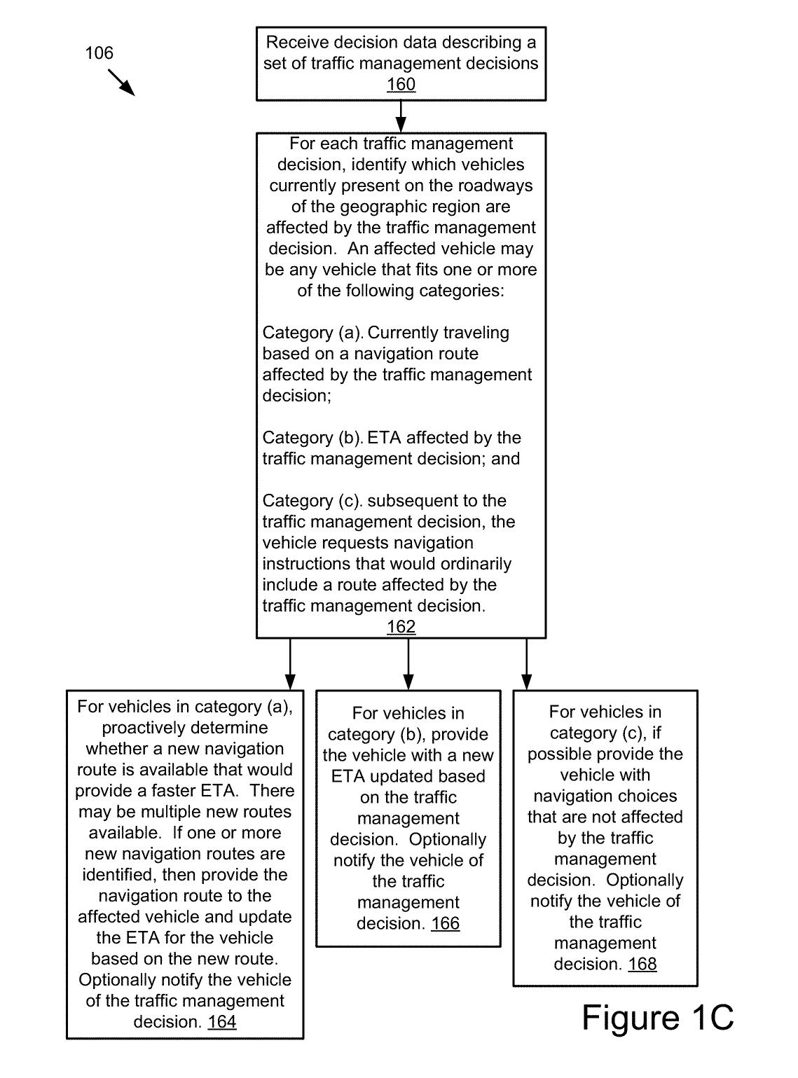

FIG. 1A is a block diagram illustrating an example operating environment 100 for an assistance system 199 according to some implementations.

The illustrated operating environment 100 includes: a roadway 102 representing a set of roadways in a geographic area managed by a roadway authority; a traffic management center 101 and an assistance server 103.

In some implementations, the traffic management center 101 may be operated by the roadway authority that manages the set of roadways represented by roadway 102.

In some implementations, the assistance server 103 may be operated by an entity that favors a set of selected vehicles 116 traveling along the roadways represented by roadway 102. The entity may be a manufacturer of the set of selected vehicles 116. For example, the set of selected vehicles 116 may consist of vehicles manufactured by Toyota and Toyota may operate the assistance server 103 for the benefit of the selected vehicles 116.

In some implementations, the selected vehicles 116 may include DSRC-enabled vehicles. In some implementations, the selected vehicles 116 may include a DSRC-compliant GPU unit.

The roadway 102 may represent a set of roadways that includes one or more roadways in the geographic area managed by the roadway authority. The set of vehicles may include one to ten roadways, ten to one hundred roadways, hundreds of roadways or even thousands of roadways. In some implementations, the roadway 102 may represent each roadway managed by the roadway authority for the geographic region.

The roadways represented by roadway 102 may include one or more vehicles traveling along the roadways. For example, the roadway 102 may include a first cluster of vehicles 110, a second cluster of vehicles 112 . . . and a N^{th} cluster of vehicles 114, wherein “N” represents any positive number greater than two. Each cluster 110, 112, 114 includes one or more vehicles. One or more of these clusters includes the selected vehicles 116. For example, a first subset of the vehicles included in the N^{th} cluster of vehicles 114 are DSRC-enabled vehicles that are favored by the entity that operates the assistance server 103, and so, the vehicles included in this first subset form a portion of the vehicles included in the selected vehicles 116. In some implementations, a second subset of the vehicles included in the first cluster of vehicles 110 are include DSRC-enabled vehicles that are favored by the entity that operates the assistance server 103, and so, the vehicles included in this second subset form a portion of the vehicles included in the selected vehicles 116. In some implementations, a third subset of the vehicles included in the second cluster of vehicles 112 are DSRC-enabled vehicles that are favored by the entity that operates the assistance server 103, and so, the vehicles included in this third subset form a portion of the vehicles included in the selected vehicles 116.

In some implementations, different clusters of vehicles 110, 112, 114 may be located on different roadways from one another, or otherwise have a meaningful difference from one another. For example, the first cluster of vehicles 110 may be traveling on a different set of roadways than the second cluster of vehicles 112.

The roadways represented by roadway 102 may include one or more traffic management devices that are installed along the roadways. For example, the roadway 102 may include a first traffic management device 111, a second traffic management device 113 . . . and a N^{th} traffic management device 115, wherein “N” represents any positive number greater than two.

In some implementations, one or more of the traffic management devices 111, 113, 115 may be networked-enabled. For example, one or more of the traffic management devices 111, 113, 115 may include a processor and a communication unit similar to the processor 225 and the communication unit 245 described below with reference to FIG. 4A. In some implementations, one or more of the traffic management devices 111, 113, 115 may be DSRC-enabled to receive and transmit DSRC messages including, for example, BSMs and DSRC probes transmitted by the vehicles included in one or more of the first cluster of vehicles 110, the second cluster of vehicles 112, the N^{th} cluster of vehicles 114 and the set of selected vehicles 116.

In some implementations, one or more of the traffic management devices 111, 113, 115 may be communicatively coupled to the traffic management center 101. For example, one or more of the traffic management devices 111, 113, 115 may be communicatively coupled to the traffic management center 101 via a wireless network, such as network 105, or a hard-wired connection.

The roadway authority for the geographic region may control the operation of the traffic management devices 111, 113, 115. For example, the traffic management center 101 operated by the roadway authority may control the operation of the traffic management devices 111, 113, 115 via the communicative coupling.

In some implementations, the traffic management devices 111, 113, 115 may control the flow of traffic along the roadways of the geographic region. For example, the traffic management devices 111, 113, 115 may control the flow of traffic by performing one of the following example tasks: (1) opening a lane of traffic; (2) closing a lane of traffic; (3) changing the flow of traffic in a bidirectional lane of traffic; (4) adaptively metering traffic flow in an on-ramp; (5) adaptively controlling traffic lights; (6) closing a bridge; (7) opening a bridge; (8) rerouting traffic; (9) closing an exit; and (10) opening an exit, etc. In some implementations, one or more of the traffic management devices 111, 113, 115 may be assisted by one or more human roadway workers in the performance of their tasks.

In some implementations, the different traffic management devices 111, 113, 115 may be located on different roadways from one another, or otherwise have a meaningful difference from one another. For example, the first traffic management device may be a traffic metering light on an on-ramp of a first roadway while the second traffic management device may be a traffic light at an intersection of a second roadway and a third roadway.

The traffic management center 101 may include a processor-based computing device configured to control the operation of one or more of traffic management devices 111, 113, 115. The traffic management center 101 may control the operation of one or more of the traffic management devices 111, 113, 115 based on the traffic management decisions of the roadway authority, and thereby modify the flow of traffic along the roadways of the geographic region.

In some implementations, the traffic management center 101 may include a hardware server, a personal computer, a laptop, a tablet-based computing device, a smartphone or some other processor-based computing device.

In some implementations, the traffic management center 101 may implement the traffic management decisions of the human operators of the traffic management center 101 who may also be human employees or agents of the roadway authority.

In some implementations, the traffic management center 101 include code and routines configured to receive data (e.g., BSM data, DSRC probe data, traffic reports, police reports, hospital reports, homeland security reports, weather data, map data, real time satellite maps, aerial photographs, etc.) and make at least some of the traffic management decisions based on this data.

The decision data 194 may include data describing the decisions of the roadway authorities. For example, the decision data 194 may describe one or more of the following decisions: (1) a decision to open a lane of traffic; (2) a decision to close a lane of traffic; (3) a decision to change the flow of traffic in a bidirectional lane of traffic; (4) a decision to adaptively meter traffic flow in an on-ramp; (5) a decision to adaptively control traffic lights; (6) a decision to close a bridge; (7) a decision to open a bridge; (8) a decision to reroute traffic; (9) a decision to close an exit; and (10) a decision to open an exit, etc. Other decisions are possible.

The network 105 can be a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices may communicate. In some implementations, the network 105 may be a peer-to-peer network. The network 105 may also be coupled to or includes portions of a telecommunications network for sending data in a variety of different communication protocols. In some implementations, the network 105 includes Bluetooth communication networks or a cellular communications network for sending and receiving data including via DSRC, short messaging service (SMS), multimedia messaging service (MMS), hypertext transfer protocol (HTTP), direct data connection, WAP, e-mail, millimeter wave communication, etc.

The traffic management center 101 may be communicatively coupled to the network 105. The traffic management center 101 may share the decision data 194 with the assistance server 103 via the network 105 or a hard wired communicative coupled shared with the assistance server 103.

One or more of the selected vehicles 116 are communicatively coupled to the network 105. The one or more of the selected vehicles 116 may communicate with the assistance server 103 via the network. For example, a vehicle included in the set of selected vehicles 116 may transmit a query for navigation assistance to the assistance server 103 via the network 105 and the assistance server 103 may provide the navigation assistance to the vehicle via the network 105.

The assistance server 103 includes a hardware server. The assistance server 103 may provide assistance to the selected vehicles 116. In some implementations, the assistance server 103 may provide assistance to the selected vehicles 116 based on the decision data 194. The assistance may include responding to queries received from the selected vehicles 116 via the network 105. The assistance may include receiving the queries, analyzing the queries and providing navigation choices or ETA estimates that are responsive to the queries.

In some implementations, the assistance server 103 may include a processor, a non-transitory memory and hardware that provides network communication capabilities. The assistance server 103 is described in more detail below with regards to FIG. 4A according to some implementations.

The assistance server 103 may include one or more of the following: the decision data 194; an assistance system 199; and assistance data 196.

The decision data 194 was described above in relation to the traffic management center 101, and so, that description will not be repeated here.

The assistance system 199 may include code and routines configured to receive queries from the selected vehicles 116 and provide the selected vehicles 116 with navigation choices and ETA estimates that are determined based in part on the decision data 194.

For example, the assistance system 199 may receive a query from a vehicle included in the set of selected vehicles 116. The query may be received via the network 105. The assistance server 103 may include a memory that stores directory data 405 (depicted in FIG. 4A), navigation data 410 (depicted in FIG. 4A) and the decision data 194.

The directory data 405 may include a data structure that stores a set of destinations (e.g., businesses, tourist destinations, parks or any location that has a physical address). The directory data 405 may be configured so that it is searchable based on a name of the destination, a physical address of the destination or a category that is applicable to the destination. The category may include a general description of a type of destination, such as “gas station” (instead of a name of a specific gas station), “grocery store” (instead of a name of a specific grocery store), “park” (instead of a name of a specific park), “Mexican restaurant” (instead of a name of a specific Mexican restaurant), etc.

The navigation data 410 may include the data necessary to determine one or more navigation routes from a current location of a vehicle to the physical address of the destinations described by the directory data 405. Both the navigation data 410 and the directory data 405 are depicted in FIG. 4A.

The query received from the vehicle may include data describing one or more of the following: a current location of the vehicle as determined by a DSRC-compliant GPS unit; a search term indicating a name of a destination or a category of destination; and any other filters that the user may select for the query (e.g., how close the destination must be from the current location of the vehicle).

The assistance system 199 may receive the query and identify one or more of the following: (1) one or more navigation choices responsive to the query; and (2) one or more ETAs associated with each of the one or more navigation choices.

The navigation choices may include data describing (1) one or more destinations from the directory data 405 that match the search term and any filters included in the query and (2) for each of the matching destinations, a navigation route including navigation instructions for driving from the current location of the vehicle to the physical address of the matching destination. Optionally, each navigation choice may be associated with its own ETA.

The ETA may include data describing an estimated time for the vehicle to travel from its current location to the physical address of the destination associated with the ETA.

In some implementations, the assistance system 199 may determine the one or more navigation choices and the one or more ETAs based at least in part on one or more of the following: the query; the directory data 405; the navigation data 410; and the decision data 194. For example, the navigation routes included in the navigation choices may be configured so that the vehicle avoids being affected by a traffic decision made by the roadway authority. For example, the traffic decision may include closing a bridge and the navigation route may include a set of roadways to be traveled by the vehicle that are selected by the assistance system 199 so that the vehicle avoids a negative effect of the bridge being closed (e.g., the roadways included in the navigation route may be selected by the assistance system 199 so that they do not include travel over the bridge, the roadways included in the navigation route may be selected by the assistance system 199 so that they are optimized to achieve the quickest ETA after factoring in the effect of the bridge being closed, etc.). This benefits the driver of the vehicle by providing them with a better driving experience, and it benefits the roadway authority by minimizing the negative implications of their traffic management decision.

In another example, the assistance system 199 may calculate the one or more ETAs associated with the different navigation choices after factoring in the effect of a traffic decision made by the roadway authority. For example, if the traffic decision includes closing a bridge, the assistance system 199 may determine the effect of the bridge closure on the navigation routes and determine the ETAs based in part on the effect of the bridge closure.

The assistance data 196 may describe one or more of the following: one or more navigation choices determined by the assistance system 199 based in part on the decision data 194; and one or more ETAs determined by the assistance system 199 based in part on the decision data 194.

The assistance system 199 may transmit the assistance data 196 to the vehicle included in the set of selected vehicles 116 via the network 105. In some implementations, the assistance data 196 may be a response to the query described above. The user of the vehicle may select one of the navigation choices, which is not referred to as a “selected navigation choice” or a “selected navigation route.”

In some implementations, roadway authority may make a new traffic management decision and the traffic management center 101 may provide additional decision data 194 after a vehicle begins to travel along a selected navigation route. The assistance system 199 may include code and routines configured to respond to the decision data 194 by causing a processor to execute one or more of the steps described below with reference to method 106 of FIG. 1C.

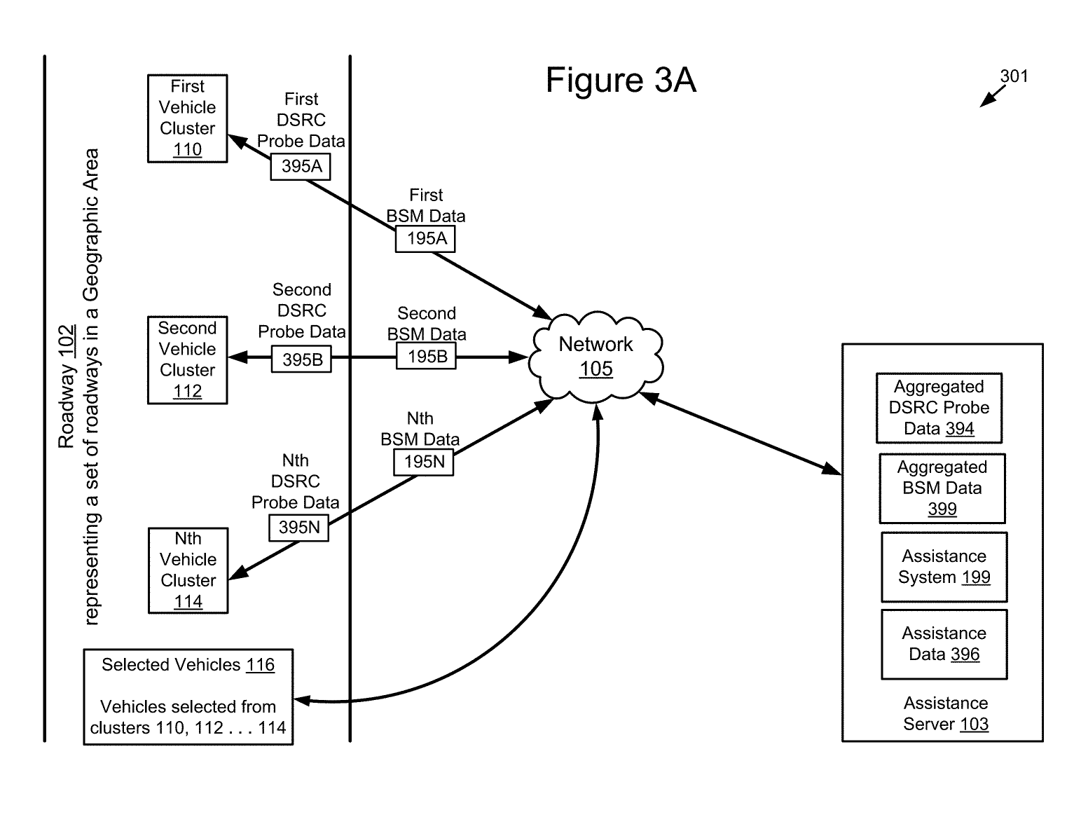

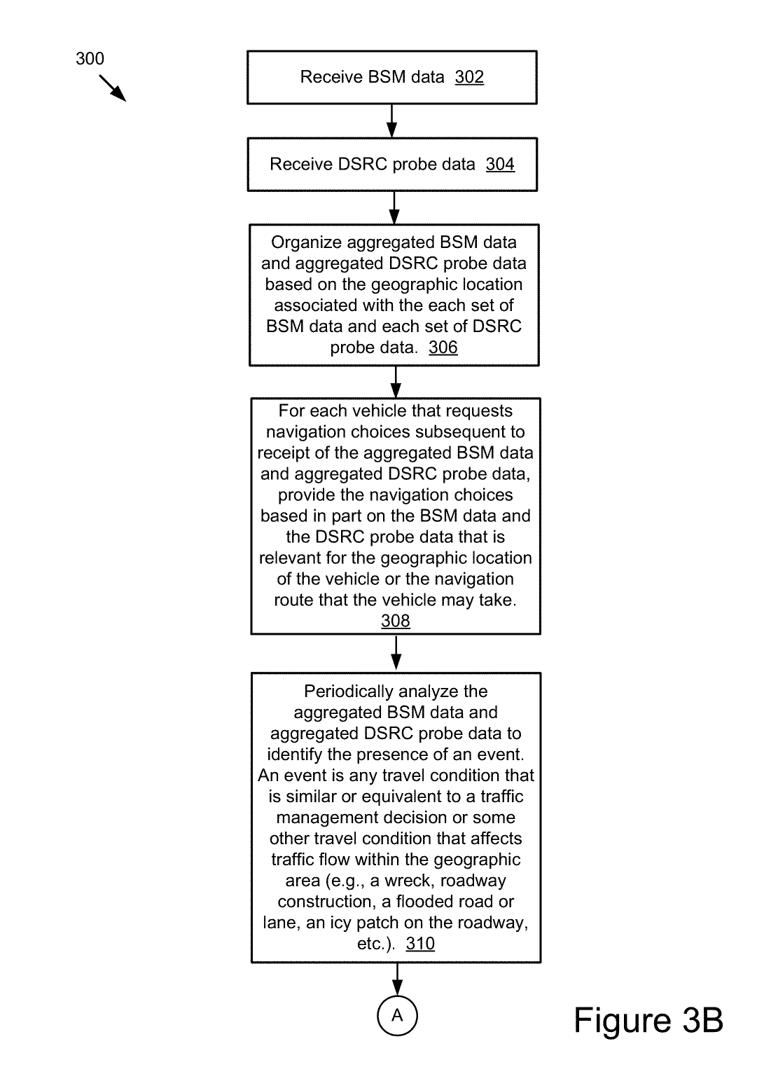

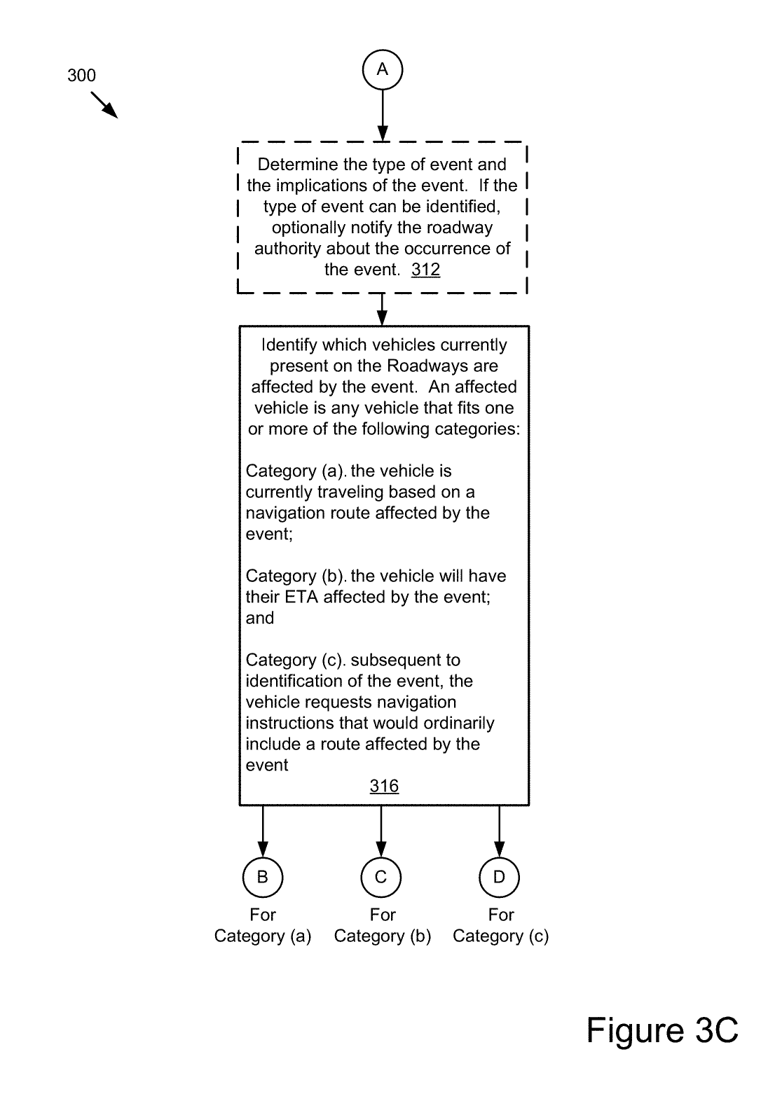

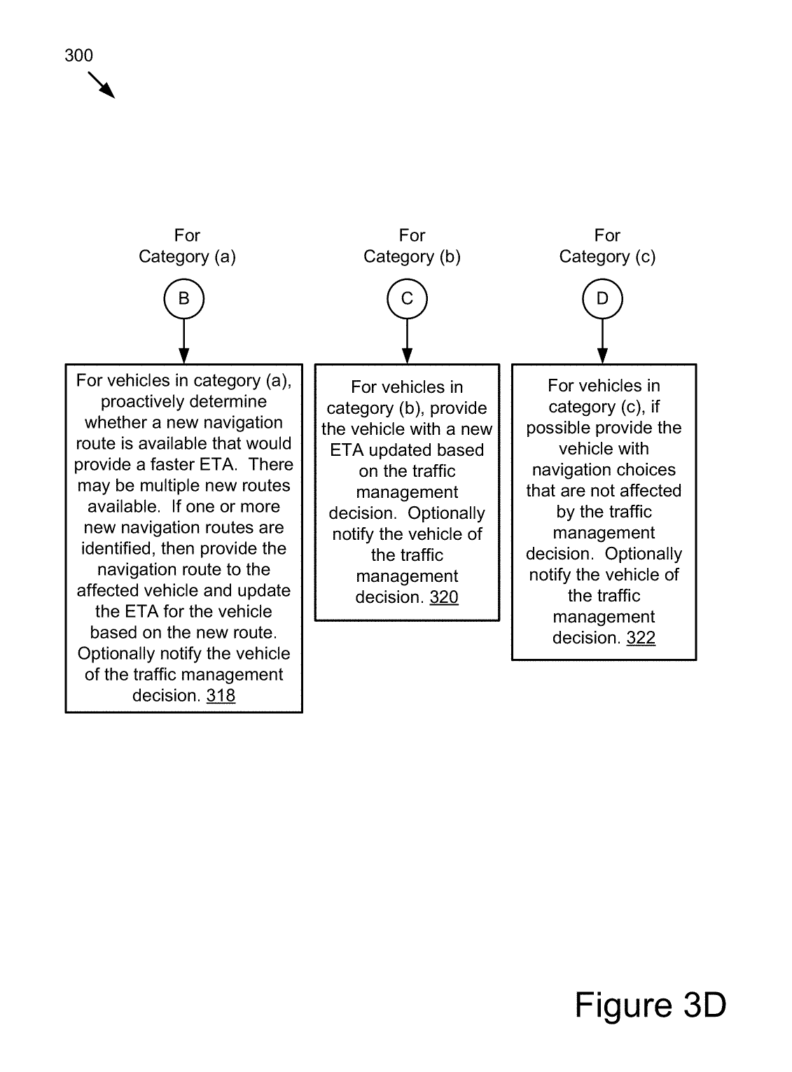

In some implementations, the assistance system 199 may include code and routines configured to cause a processor to execute one or more of the steps described below with reference to method 300 of FIGS. 3B, 3C and 3D.

The assistance system 199 is described in more detail below with reference to FIGS. 1B, 1C, 2A, 2B, 3A, 3B, 3C, 3D and 4A.

Referring now to FIG. 1B, depicted is a block diagram illustrating an example operating environment 104 for an assistance system 199 according to some implementations. FIG. 1B includes elements similar to those described above for FIG. 1A, and so, those descriptions will not be repeated here. In operating environment 104, one or more of the traffic management devices 111, 113, 115 are communicatively coupled to the network 105 so that they may wirelessly communicate with the traffic management center 101.

Referring now to FIG. 1C, depicted is a flowchart of an example method 106 for providing assistance to selected vehicles 116 traveling along a roadway based on traffic management decisions of a roadway authority, according to some implementations.

At step 160, the assistance system 199 may receive the decision data 194 describing a set of traffic management decisions of the roadway authority.

At step 162, or each traffic management decision included in the set, the assistance system 199 may identify which vehicles currently present on the roadways of the geographic region are affected by the traffic management decision. An affected vehicle is any vehicle that fits into one or more of the following categories: category (a)—the vehicle is currently traveling based on a navigation route affected by the traffic management decision; category (b)—the vehicle has received an ETA that is affected by the traffic management decision; and category (c)—subsequent to the traffic management decision being made by the roadway authority, the vehicle requests navigation instructions that would ordinarily include a navigation route affected by the traffic management decision.

Step 164 may apply to vehicles in category (a). For vehicles in category (a), the assistance system 199 may proactively determine whether a new navigation route is available that would provide a faster ETA. There may be multiple new routes available. If one or more new navigation routes are identified, then the assistance system 199 may provide the navigation route to the affected vehicle and update the ETA for the vehicle based on the new route. The new navigation route and the new ETA may be described by assistance data 196. Optionally the assistance system 199 may notify the vehicle of the traffic management decision. This notification may include the assistance system 199 generating graphical data that causes a display of the vehicle to depict a graphical user interface (“GUI”) that describes the traffic management decision.

Step 166 may apply to vehicles in category (b). For vehicles in category (b), the assistance system 199 may provide the vehicle with a new ETA updated based on the traffic management decision. The new ETA may be described by assistance data 196. Optionally the assistance system 199 may notify the vehicle of the traffic management decision. This notification may include the assistance system 199 generating graphical data that causes a display of the vehicle to depict a GUI that describes the traffic management decision.

Step 168 may apply to vehicles in category (c). For vehicles in category (c), the assistance system 199 may, if possible, provide the vehicle with navigation choices that are not affected by the traffic management decision. The navigation choices may be described by assistance data 196. Optionally the assistance system 199 may notify the vehicle of the traffic management decision. This notification may include the assistance system 199 generating graphical data that causes a display of the vehicle to depict a GUI that describes the traffic management decision.

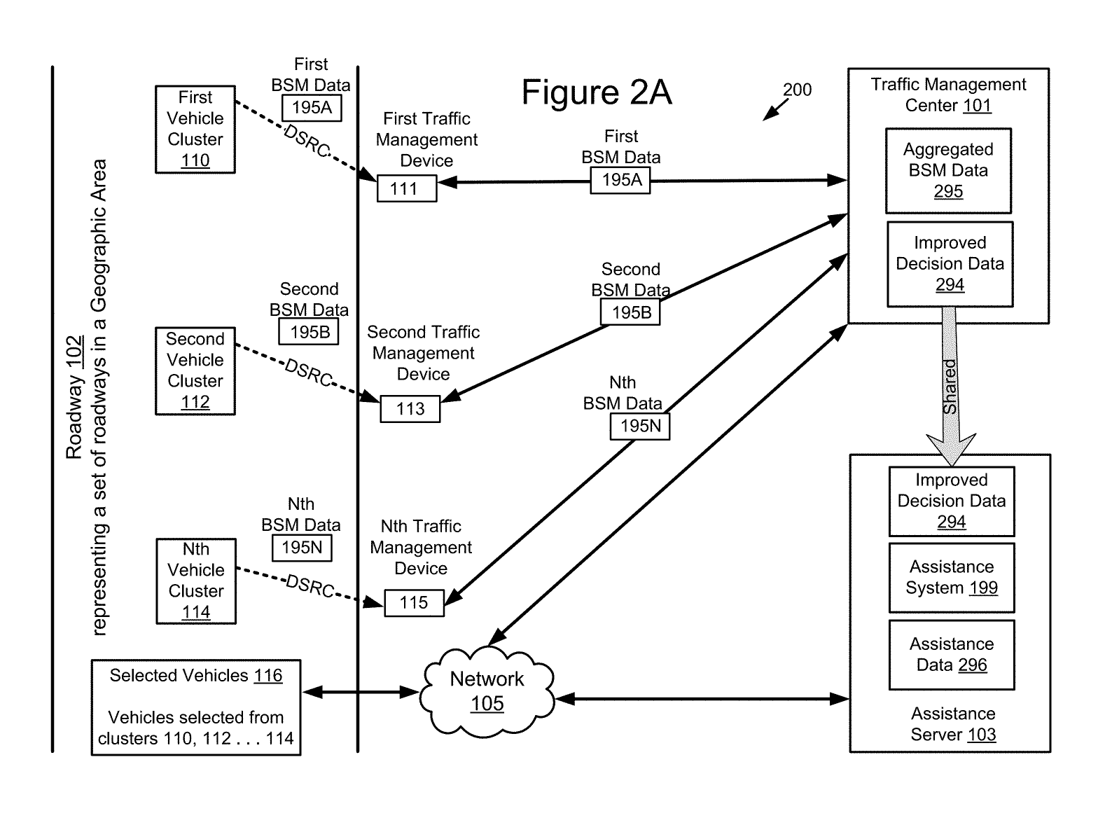

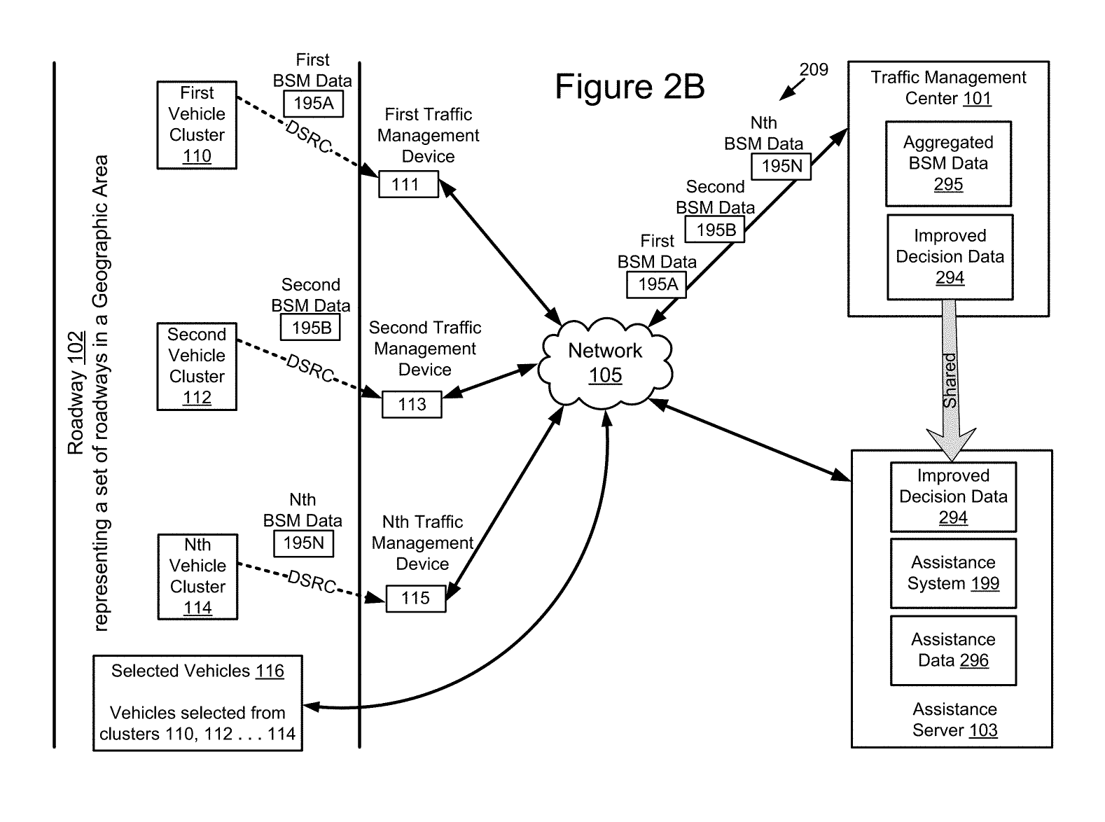

Referring now to FIG. 2A, depicted is a block diagram illustrating an example operating environment 200 for an assistance system 199 according to some implementations. FIG. 2A includes elements similar to those described above with reference to FIG. 1A, and so, those descriptions will not be repeated here.

In FIG. 2A, a subset of the vehicles included in the first cluster of vehicles 110, second cluster of vehicles 112 and the N^{th} cluster of vehicles 114 are DSRC-enabled. These vehicles broadcast a BSM that may be received by one or more of the first traffic management device 111, the second traffic management device or the N^{th} traffic management device 115 the vehicles are within DSRC range of one or more of these traffic management devices. The BSM may include first BSM data 195A, second BSM data 195B or N^{th} BSM data 195N (referred to individually or collectively as “BSM data 195”). The traffic management devices 111, 113, 115 may transmit the BSM data 195 to the traffic management center 101 via a hard wired communicative coupling shared with the traffic management center 101. The traffic management center 101 may aggregate the BSM data 195 to form aggregated BSM data 295 that is stored on a non-transitory memory of the traffic management center 101 (similar to memory 227 described below for FIG. 4A). The roadway authority may improve their traffic management decisions based on the aggregated BSM data 295. The traffic management decisions that are improved based on the aggregated BSM data 295 are described by the improved decision data 294. The roadway authority may provide the improved decision data 294 to the assistance system 199 via the network 105 or a hardwired communicatively coupling shared with the assistance server 103. The assistance system 199 may use the improved decision data 294 to generate the assistance data 196. The assistance system 199 may determine the assistance data 196 based on the improved decision data 294 similar to the way described above for FIGS. 1A, 1B and 1C in which the assistance system 199 used the decision data 194 to determine the assistance data 196.

Referring now to FIG. 2B, depicted is a block diagram illustrating an example operating environment 209 for an assistance system 199 according to some implementations. FIG. 2B includes elements similar to those described above with reference to FIGS. 1A and 2A, and so, those descriptions will not be repeated here.

In the operating environment 200 of FIG. 2A, the traffic management devices 111, 113, 115 may transmit the BSM data 195 to the traffic management center 101 via a hard wired communicative coupling shared with the traffic management center 101. By comparison, in the operating environment 209 of FIG. 2B, the traffic management devices 111, 113, 115 are communicatively coupled to the network 105. The traffic management center 101 is also communicatively coupled to the network 105. The traffic management devices 111, 113, 115 may transmit the BSM data 195 to the traffic management center 101 via the network 105.

Referring now to FIG. 3A, depicted is a block diagram illustrating an example operating environment 301 for an assistance system 199 according to some implementations.

The selected vehicles 116 are included in the first cluster 110, the second cluster 112 and the N^{th} cluster 114. The selected vehicles 116 are DSRC-equipped. The selected vehicles 116 may transmit DSRC messages to the assistance server 103 via the network 105 (which may be a DSRC network). The DSRC messages may include the first DSRC probe data 395A, the second DSRC probe data 395B and the N^{th} DSRC probe data 395N (referred to individually or collectively as “DSRC probe data 395”). The DSRC probe data 395 may be transmitted to the assistance server 103. The assistance server 103 may store this data as the aggregated DSRC probe data 394.

In some implementations, each of the DSRC probes describes a specific vehicle included in the set of selected vehicles 116. Each DSRC probe may include DSRC probe data 395. The DSRC probe data 395 may describe a lane of travel for the specific vehicle, a speed of travel for the specific vehicle, a heading of travel for the specific vehicle and a path of travel for the specific vehicle.

In some implementations, the DSRC-enabled vehicles will include a DSRC-compliant GPS unit and the BSM data or DSRC probe data will specify which lane a vehicle is traveling in as well as its speed of travel and path history.

The selected vehicles 116 may also broadcast BSMs that are received by the assistance server 103. The BSMs may include the first BSM data 195A, the second BSM data 195B and the N^{th} BSM data 195N. The assistance server 103 may store this data as the aggregated BSM data 399.

The assistance system 199 may determine one or more navigation choices and one or more ETAs that are improved based on the aggregated DSRC probe data 394 and the aggregated BSM data 399.

For example, the assistance system 199 may analyze one or more of the aggregated DSRC probe data 394 and the aggregated BSM data 399 to identify a traffic event that affects travel along at least one of the roadways of a geographic region or at least one or the roadways included in a navigation route. A traffic event may include one or more of the following: a wreck; roadway construction; a traffic stop involving a police vehicle; a lane flooded by a liquid; and an icy patch on a roadway. In this way, the assistance system 199 may determine assistance data 396 based at least in part on one or more of the aggregated DSRC probe data 394 and the aggregated BSM data 399. The assistance data 396 may describe one or more of a navigation route and an ETA. This option is beneficial because it does not require cooperation with a roadway authority or access to decision data 194, 294.

In some implementations, the selected vehicles 116 may probe other DSRC-equipped vehicles (or DSRC-equipped devices such as smartphones) along the roadway 102 for information describing their current and future conditions, including their path history and future path. The selected vehicles 116 may include information may be included in the DSRC probe data 395 and may describe vehicles that are not included in the selected vehicles 116 but are located in the geographic region. In some implementations, the assistance system 199 may improve ETA estimates and navigation choices provided to the selected vehicles 116 as assistance data 396 based on aggregated DSRC probe data 394 that includes DSRC probe data 395 received from the selected vehicles 116 and DSRC-equipped vehicles that are not included in the selected vehicles 116.

The aggregated DSRC probe data 394 and the aggregated BSM data 399 may include GPS data with a lane-level of granularity because the selected vehicles 116 include a DSRC-compliant GPS unit. Accordingly, in some implementations the assistance system 199 may use the aggregated DSRC probe data 394 or the aggregated BSM data 399 to: (1) adjust ETA data based on the actual lane the vehicle is traveling in; (2) provide recommendations to the driver about what their ETA would be if they changed lanes; and (3) provide navigation choices to the driver that include recommendations for which lane they should travel in to reduce ETA. Other uses are possible.

The assistance system 199 may include code and routines configured to cause a processor to execute one or more steps of the method 300 described below with reference to FIGS. 3B, 3C and 3D.

Referring now to FIGS. 3B-3D, depicted are a flowchart of an example method 300 for providing assistance to selected vehicles 116 traveling along a roadway 102 based on DSRC-related data, according to some implementations.

Referring to FIG. 3B, step 302 includes the assistance system 199 receiving BSM data 195.

Step 304 includes the assistance system 199 receiving DSRC probe data 395.

Step 306 includes the assistance system 199 organizing the aggregated BSM data 399 and the aggregated DSRC probe data 394 based on the geographic location or area associated with each set of BSM data 195 and each set of DSRC probe data 395. For example, the first DSRC probe data 395A and the first BSM data 195A may be associated with a first geographic location or first area. The second DSRC problem data 395B and the second BSM data 195B may be associated with a second geographic location or a second area that is different from the first geographic location or the first area. The DSRC probe data 395 and the BSM data 195 includes GPS data which may utilized by the assistance system 199 to perform the organization of step 306.

At step 308, for each vehicle that requests navigation choices (i.e., via a query) subsequent to receipt of the aggregated BSM data 399 and aggregated DSRC probe data 394, the assistance system 199 may determine the navigation choices for the vehicle based in part on the organized BSM data and the organized DSRC probe data (i.e., resulting from step 306) that is geographically relevant to the current geographic location of the vehicle or the navigation route that the vehicle may take based on the destination included in the query and the current geographic location of the vehicle.

Step 310 may include the assistance system 199 periodically analyzing the aggregated BSM data 399 and aggregated DSRC probe data 394 to identify the presence of an event. An event is any travel condition that is similar or equivalent to a traffic management decision of the roadway authority or some other travel condition that affects traffic flow within the geographic area (e.g., a wreck, roadway construction, a road or lane flooded with a liquid, an icy patch on the roadway, etc.).

In some implementations, the event may be indicated in the aggregated BSM data 399 and aggregated DSRC probe data 394 by the presence in a pattern among a plurality of vehicles that are at the same location as described by the GPS data. For example, the GPS data may indicate that vehicles at a particular location have a pattern of behavior that indicates an event. The behavior may include, for example, slowing down, speeding up, hard breaking, stopping, crossing a lane of opposing traffic, changing lanes, turning around, modifying their route, swerving, hydroplaning, etc.

Referring now to FIG. 3C. Step 312 is depicted with a dashed line in FIG. 3C to indicate that it is an optional step of method 300. Step 312 includes the assistance system 199 determining the type of event and the implications of the event. If the type of event can be identified, the assistance system 199 may notify the roadway authority about the occurrence of the event.

For example, the event may be indicated in the aggregated BSM data 399 and aggregated DSRC probe data 394 by the presence in a pattern among a plurality of vehicles that are at the same location as described by the GPS data. For example, the GPS data may indicate that vehicles at a particular location have a pattern of hydroplaning, which would indicate the presence of a road or lane flooded with a liquid.

Step 316 may include the assistance system 199 identifying which of the selected vehicles 116 currently present on the roadways are affected by the event. An affected vehicle is any vehicle that fits one or more of the following categories: category (a)—the vehicle is currently traveling based on a navigation route affected by the event (e.g., the navigation route may have been provided by the assistance system); category (b)—the vehicle will have their ETA affected by the event; and category (c)—subsequent to identification of the event in step 310, the vehicle requests navigation instructions that would ordinarily include a route affected by the event.

Referring now to FIG. 3D. Step 318 applies to vehicles in category (a). At step 318, the assistance system 199 may proactively determine whether a new navigation route is available that would provide a faster ETA. There may be multiple new routes available. If one or more new navigation routes are identified, then the assistance system 199 may provide the navigation route to the affected vehicle and update the ETA for the vehicle based on the new route. Optionally the assistance system 199 may notify the vehicle of the event. This notification may include the assistance system 199 generating graphical data that causes a display of the vehicle to depict a GUI that describes the event.

Step 320 applies to vehicles in category (b). At step 320, the assistance system 199 may provide the vehicle with a new ETA updated based on the event. Optionally the assistance system 199 may notify the vehicle of the event. This notification may include the assistance system 199 generating graphical data that causes a display of the vehicle to depict a GUI that describes the event.

Step 322 applies to vehicles in category (c). At step 322, the assistance system 199 may provide the vehicle with navigation choices that are not affected by the event. Optionally the assistance system 199 may notify the vehicle of the event. This notification may include the assistance system 199 generating graphical data that causes a display of the vehicle to depict a GUI that describes the event.

FIG. 4A is a block diagram illustrating an example computer system 400 including the assistance system 199 according to some implementations. The computer system 400 may include the assistance server 103.

The computer system 400 may include the assistance system 199, a processor 225, a communication unit 245, a storage 241 and a memory 227 according to some examples. The components of the computer system 400 are communicatively coupled by a bus 220.

In the illustrated implementation, the processor 225 is communicatively coupled to the bus 220 via a signal line 238. The memory 227 is communicatively coupled to the bus 220 via a signal line 244. The communication unit 245 is communicatively coupled to the bus 220 via a signal line 246. The storage 241 is communicatively coupled to the bus 220 via a signal line 242.

The processor 225 includes an arithmetic logic unit, a microprocessor, a general purpose controller, or some other processor array to perform computations and provide electronic display signals to a display device. The processor 225 is coupled to the bus 220 for communication with the other components via signal line 238. The processor 225 processes data signals and may include various computing architectures including a complex instruction set computer (CISC) architecture, a reduced instruction set computer (RISC) architecture, or an architecture implementing a combination of instruction sets. Although FIG. 4A includes a single processor 225, multiple processors may be included. Other processors, operating systems, sensors, displays, and physical configurations may be possible.

The memory 227 stores instructions or data that may be executed by the processor 225. The memory 227 is coupled to the bus 220 for communication with the other components via signal line 244. The instructions or data may include code for performing the techniques described herein. The memory 227 may be a dynamic random access memory (DRAM) device, a static random access memory (SRAM) device, flash memory, or some other memory device. In some implementations, the memory 227 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

As illustrated in FIG. 2, the memory 227 stores one or more of the following: the decision data 194; the improved decision data 294; the assistance data 196; the assistance data 296; the aggregated DSRC probe data 394; the aggregated BSM data 399; the assistance data 394; the directory data 405; and the navigation data 410. These elements of the memory 227 are described above, and so, these descriptions will not be repeated here. Although not pictured in FIG. 4A, the memory 227 may GPS data for displaying a GUI as described above.

The communication unit 245 transmits and receives data to and from a network 105 or to another communication channel. The network 105 or the communication channel may include DSRC. For example, the communication unit 245 may include a DSRC antenna and other hardware or software necessary to make the assistance system 199 a DSRC-enabled device.

The communication unit 245 is coupled to the bus 220 via signal line 246. In some implementations, the communication unit 245 includes a port for direct physical connection to the network 105 or to another communication channel. For example, the communication unit 245 includes a USB, SD, CAT-5, or similar port for wired communication with the network 105. In some implementations, the communication unit 245 includes a wireless transceiver for exchanging data with the network 105 or other communication channels using one or more wireless communication methods, including IEEE 802.11, IEEE 802.16, BLUETOOTH®, or another suitable wireless communication method.

In some implementations, the communication unit 245 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some implementations, the communication unit 245 includes a wired port and a wireless transceiver. The communication unit 245 also provides other conventional connections to the network 105 for distribution of files or media objects using standard network protocols including TCP/IP, HTTP, HTTPS, and SMTP, millimeter wave, DSRC, etc.

The storage 241 can be a non-transitory storage medium that stores data for providing the functionality described herein. The storage 241 may be a dynamic random access memory (DRAM) device, a static random access memory (SRAM) device, flash memory, or some other memory devices. In some implementations, the storage 241 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis. The storage 241 is communicatively coupled to the bus 220 via signal line 242.

In the illustrated implementation shown in FIG. 4, the assistance system 199 includes a communication module 202, a data module 204, an ETA module 205 and a navigation choice module 206. These components of the assistance system 199 are communicatively coupled to each other via the bus 220. In some implementations, components of the assistance system 199 can be stored in a single server or device. In some other implementations, components of the assistance system 199 can be distributed and stored across multiple servers or devices.

The communication module 202 can be software including routines for handling communications between the assistance system 199 and other components of the computer system 400. In some implementations, the communication module 202 can be a set of instructions executable by the processor 225 to provide the functionality described below for handling communications between the assistance system 199 and other components of the computer system 400. In some implementations, the communication module 202 can be stored in the memory 227 of the computer system 400 and can be accessible and executable by the processor 225. The communication module 202 may be adapted for cooperation and communication with the processor 225 and other components of the computer system 400 via signal line 222.

The communication module 202 sends and receives data, via the communication unit 245, to and from one or more of a vehicle, a traffic management device, the network 105 and the traffic management center 101. For example, the communication module 202 receives, via the communication unit 245, the decision data 194, BSM data 195, the DSRC probe data 395, etc.

In some implementations, the communication module 202 receives data from components of the assistance system 199 and stores the data in one or more of the storage 241 and the memory 227. For example, the communication module 202 receives aggregated DSRC probe data 394 or aggregated BSM data 399 from the data module 204 and stores this data in the memory 227.

In some implementations, the communication module 202 may handle communications between components of the assistance system 199. For example, the communications module 202 may handle communications between the data module 204 and the ETA module 205.

The data module 204 can be software including routines for forming the aggregated DSRC probe data 394 or the aggregated BSM data 399 based on one or more sets of DSRC data 395 or one or more sets of BSM data 195, respectively. In some implementations, the data module 204 can be stored in the memory 227 of the computer system 400 and can be accessible and executable by the processor 225. The data module 204 may be adapted for cooperation and communication with the processor 225 and other components of the computer system 400 via signal line 224.

In some implementations, the data module 204 may organize the aggregated BSM data 399 and the aggregated DSRC probe data 394 based on the geographic location or area associated with each set of BSM data 195 and each set of DSRC probe data 395. For example, the first DSRC probe data 395A and the first BSM data 195A may be associated with a first geographic location or first area. The second DSRC problem data 395B and the second BSM data 195B may be associated with a second geographic location or a second area that is different from the first geographic location or the first area. The DSRC probe data 395 and the BSM data 195 includes GPS data which may utilized by the data module 204 to perform the organization described above for step 306 of method 300.

In some implementations, the data module 204 may periodically analyze the aggregated BSM data 399 and aggregated DSRC probe data 394 to identify the presence of an event. An event may include any travel condition that is similar or equivalent to a traffic management decision of the roadway authority or some other travel condition that affects traffic flow within the geographic area (e.g., a wreck, roadway construction, a road or lane flooded with a liquid, an icy patch on the roadway, etc.).

In some implementations, the event may be indicated in the aggregated BSM data 399 and aggregated DSRC probe data 394 by the data module 204 identifying a pattern among a plurality of vehicles that are at the same location as described by the GPS data included in the aggregated BSM data 399 or the aggregated DSRC probe data 394. For example, the GPS data may indicate that vehicles at a particular location have a pattern of behavior that indicates an event. The behavior may include, for example, slowing down, speeding up, hard breaking, stopping, crossing a lane of opposing traffic, changing lanes, turning around, modifying their route, swerving, hydroplaning, etc.

In some implementations, the data module 204 may determine the type of event and the implications of the event. For example, the event may be indicated in the aggregated BSM data 399 and aggregated DSRC probe data 394 by the presence in a pattern among a plurality of vehicles that are at the same location as described by the GPS data. For example, the GPS data may indicate that vehicles at a particular location have a pattern of hydroplaning, which would indicate the presence of a road or lane flooded with a liquid.

In some implementations, the data module 204 may notify the roadway authority about the occurrence of the event.

In some implementations, the data module 204 may identify which of the selected vehicles 116 currently present on the roadways are affected by a traffic management decision of a roadway authority or an event. An affected vehicle is any vehicle that fits one or more of the following categories: category (a)—the vehicle is currently traveling based on a navigation route affected by the traffic management decision or the event (e.g., the navigation route may have been provided by the assistance system); category (b)—the vehicle will have their ETA affected by the traffic management decision or the event; and category (c)—subsequent to identification of the event in step 310, the vehicle requests navigation instructions that would ordinarily include a route affected by the traffic management decision or the event.

The ETA module 205 can be software including routines for determining ETAs as described above. The ETAs may be determined responsive to a query, a traffic management decision or an event. In some implementations, the ETA module 205 can be stored in the memory 227 of the computer system 400 and can be accessible and executable by the processor 225. The data module 204 may be adapted for cooperation and communication with the processor 225 and other components of the computer system 400 via signal line 280.

The navigation choice module 206 can be software including routines for determining one or more navigation choices as described above. The navigation choices may be determined responsive to a query, a traffic management decision or an event. In some implementations, the navigation choice module 206 can be stored in the memory 227 of the computer system 400 and can be accessible and executable by the processor 225. The navigation choice module 206 may be adapted for cooperation and communication with the processor 225 and other components of the computer system 400 via signal line 226.

Referring now to FIG. 4B, depicted is a block diagram illustrating an example of BSM data 195 according to some implementations.

The regular interval for transmitting BSMs may be user configurable. In some implementations, a default setting for this interval may be transmitting the BSM every 0.10 seconds or substantially every 0.10 seconds.

A BSM may be broadcasted over the 5.9 GHz DSRC band. DSRC range may be substantially 1,000 meters. In some implementations, DSRC range may include a range of substantially 100 meters to substantially 1,000 meters.

Referring now to FIG. 4C, depicted is a block diagram illustrating an example of BSM data 195 according to some implementations.

A BSM may include two parts. These two parts may include different BSM data 195 as shown in FIG. 4C.

Part 1 of the BSM data 195 may describe one or more of the following: vehicle position; vehicle heading; vehicle speed; vehicle acceleration; vehicle steering wheel angle; and vehicle size.

Part 2 of the BSM data 195 may include a variable set of data elements drawn from a list of optional elements. Some of the BSM data 195 included in Part 2 of the BSM are selected based on event triggers, e.g., anti-locking brake system (“ABS”) being activated may trigger BSM data 195 relevant to the ABS system of the vehicle.

In some implementations, some of the elements of Part 2 are transmitted less frequently in order to conserve bandwidth.

In some implementations, the BSM data 195 included in a BSM includes current snapshots of a vehicle traveling along a roadway system.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present implementations can be described above primarily with reference to user interfaces and particular hardware. However, the present implementations can apply to any type of computing device that can receive data and commands, and any peripheral devices providing services.

Reference in the specification to “some implementations” or “some instances” means that a particular feature, structure, or characteristic described in connection with the implementations or instances can be included in at least one implementation of the description. The appearances of the phrase “in some implementations” in various places in the specification are not necessarily all referring to the same implementations.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present implementations of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware implementations, some entirely software implementations or some implementations containing both hardware and software elements. In some preferred implementations, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited, to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

1. A method implemented by a computer system to assist a vehicle, the method comprising:
wirelessly providing a first navigation route to a navigation system of the vehicle to assist the vehicle to arrive at a destination, wherein the first navigation route includes one or more roadways for the vehicle to travel to arrive at the destination;
receiving decision data from a roadway authority, wherein the roadway authority is an entity that is responsible for operating a set of roadway systems in a geographic region and the decision data describes a set of traffic management decisions made by the roadway authority that affect travel along at least one of the roadways included in the first navigation route;
identifying that the vehicle is affected by the set of traffic management decisions made by the roadway authority based on GPS data received from a dedicated short range communication (DSRC)-compliant GPS unit of the vehicle indicating that the vehicle is traveling along the first navigation route, wherein the GPS data received from the DSRC-complaint GPS unit of the vehicle describes a location of the vehicle to a lane-level degree of precision;
proactively determining a second navigation route to assist the vehicle to arrive at the destination, wherein the second navigation route is configured by the computer system so that it does not include any roadway that is affected by the set of traffic management decisions made by the roadway authority; and
wirelessly providing the second navigation route to the navigation system of the vehicle to assist the vehicle to arrive at the destination and avoid being affected by the set of traffic management decisions made by the roadway authority.

2. The method of claim 1, wherein the set of traffic management decisions made by the roadway authority includes one or more of opening closing a lane or opening the lane.

3. The method of claim 1, wherein the set of traffic management decisions made by the roadway authority includes opening or closing an exit.

4. The method of claim 1, wherein the set of traffic management decisions made by the roadway authority include reconfiguring a flow of traffic in a bidirectional lane.

5. The method of claim 1, wherein the set of traffic management decisions made by the roadway authority includes opening or closing a bridge.

6. The method of claim 1, wherein the set of traffic management decisions made by the roadway authority includes rerouting traffic.

7. The method of claim 1, wherein the set of traffic management decisions made by the roadway authority includes metering traffic in an on-ramp.

8. The method of claim 1, wherein the set of traffic management decisions made by the roadway authority includes controlling traffic lights.

9. The method of claim 1, wherein the GPS data is accurate to within 1.5 meters.

10. The method of claim 1, wherein the second navigation route is determined in substantially real time upon receipt of the decision data.

11. The method of claim 1, wherein the decision data is received in substantially real time upon the decision being made by the roadway authority.

12. The method of claim 1, wherein the decision data is received prior to the decision being implemented by the roadway authority.

13. The method of claim 1, wherein the decision data is received via a wireless network that communicatively couples the computer system to a network-enabled device operated by the roadway authority.

14. The method of claim 1, wherein the decision data is determined by the roadway authority based at least in part on a set of basic safety message data (“BSM data”) included in a set of basic safety messages (“BSMs”) broadcasted by a set of vehicles traveling along the set of roadway systems in the geographic region, wherein BSM data includes one or more of the following: a set of GPS data describing locations for the set of vehicles; a set of heading data describing directions of travel for the set of vehicles; a set of velocity data describing velocities of the set of vehicles; and a set of path history data describing historical paths of travel for the set of vehicles.

15. A method implemented to assist a vehicle, the method comprising:
wirelessly providing a navigation route to a navigation system of the vehicle to assist the vehicle to arrive at a destination, wherein the navigation route includes one or more roadways for the vehicle to travel to arrive at the destination and wherein the navigation route is based on GPS data received from a dedicated short range communication (DSRC)-compliant GPS unit of the vehicle that describes a location of the vehicle to a lane-level degree of precision;
determining a first estimated time of arrival (“first ETA”) associated with the navigation route by estimating how long it will take the vehicle to travel the navigation route and arrive at the destination by traveling the navigation route;
wirelessly providing a first ETA to the navigation system of the vehicle for display to a user of the vehicle;
receiving decision data from a roadway authority, wherein the roadway authority is an entity that is responsible for operating a set of roadway systems in a geographic region and the decision data describes a set of traffic management decisions made by the roadway authority that affect travel along at least one of the roadways included in the navigation route;
proactively determining a second estimated time of arrival (“second ETA”) associated with the navigation route by estimating how long it will take the vehicle to travel the navigation route which is affected by the set of traffic management decisions and arrive at the destination by traveling the navigation route, wherein the second ETA is based on the location of an actual lane the vehicle is travelling in; and
wirelessly providing the second ETA to the navigation system of the vehicle for display to a user of the vehicle.

16. A method implemented by a computer system operable to assist a vehicle, the method comprising:
receiving decision data from a roadway authority, wherein the roadway authority is an entity that is responsible for operating a set of roadway systems in a geographic region and the decision data describes a set of traffic management decisions made by the roadway authority that affect travel along one or more roadways included in the geographic region;
receiving a request for navigation instructions to a destination from the vehicle, wherein the request includes GPS data from a dedicated short range communication (DSRC)-complaint GPS unit of the vehicle and wherein the GPS data describes a location of the vehicle to a lane-level precision;
determining a navigation route to assist the vehicle to arrive at the destination, wherein the navigation route includes a set of roadways to be traveled by the vehicle and the one or more roadways included in the set of roadways are selected by the computer system so that they do not include any roadway that is affected by the set of traffic management decisions made by the roadway authority; and
wirelessly providing the navigation route to a navigation system of the vehicle to assist the vehicle to arrive at the destination and avoid being affected by the set of traffic management decisions made by the roadway authority.

17. A method to assist a vehicle, the method comprising:
wirelessly providing a first navigation route to a navigation system of the vehicle to assist the vehicle to arrive at a destination, wherein the first navigation route includes one or more roadways for the vehicle to travel to arrive at the destination;
wirelessly receiving a set of basic safety messages (“BSMs”) describing a set of vehicles traveling along a set of roadway systems, each BSM included in the set of BSMs describing a specific vehicle included in the set of vehicles and including basic safety message data (“BSM data”) describing a lane of travel for the specific vehicle, a speed of travel for the specific vehicle and a heading of travel for the specific vehicle;
analyzing the BSM data to identify a traffic event that affects travel along at least one of the roadways included in the first navigation route;
identifying that the vehicle is affected by the traffic event based on GPS data received from the vehicle indicating that the vehicle is traveling along the first navigation route, wherein the GPS data is generated by a dedicated short range communication (DSRC)-compliant GPS unit of the vehicle and the GPS data describes a location of the vehicle to a lane-level degree of precision;
proactively determining a second navigation route to assist the vehicle to arrive at the destination, wherein the second navigation route is configured so that it does not include any roadway that is affected by the traffic event; and
wirelessly providing the second navigation route to the navigation system of the vehicle to assist the vehicle to arrive at the destination and avoid being affected by the traffic event.

18. The method of claim 17, wherein the traffic event includes a wreck.

19. The method of claim 17, wherein the traffic event includes roadway construction.

20. The method of claim 17, wherein the traffic event includes a traffic stop involving a police vehicle.

21. The method of claim 17, wherein the traffic event includes a flooded lane.

22.

23. A method to assist a vehicle, the method comprising:
wirelessly providing a first navigation route to a navigation system of the vehicle to assist the vehicle to arrive at a destination, wherein the first navigation route includes one or more roadways for the vehicle to travel to arrive at the destination;
wirelessly receiving a set of dedicated short range communication probes (“DSRC probes”) describing a set of vehicles traveling along a set of roadway systems, each DSRC probe included in the set of DSRC probes describing a specific vehicle included in the set of vehicles and including dedicated short range communication probe data (“DSRC probe data”) describing a location of the specific vehicle in a lane of travel for the specific vehicle, a speed of travel for the specific vehicle, a heading of travel for the specific vehicle and a path of travel for the specific vehicle, wherein the DSRC probes are aggregated by a set of roadside units located proximate to one or more of the roadway systems included in the set of roadway systems, wherein the DSRC probe data is generated by a dedicated short range communication (DSRC)-compliant GPS unit in each vehicle of the set of vehicles;
analyzing the DSRC probe data to identify a traffic event that affects travel along at least one of the roadways included in the first navigation route;
identifying that the vehicle is affected by the traffic event based on GPS data received from the vehicle indicating that the vehicle is traveling along the first navigation route;
proactively determining a second navigation route to assist the vehicle to arrive at the destination, wherein the second navigation route is configured so that it does not include any roadway that is affected by the traffic event; and
wirelessly providing the second navigation route to the navigation system of the vehicle to assist the vehicle to arrive at the destination and avoid being affected by the traffic event.
